(19) United States
(12) Patent Application Publication
(10) Pub. No.: US 2023/0288609 A1
(43) Pub. Date: Sep. 14, 2023

(54) OPTICAL STRUCTURE AND THE METHOD TO MAKE THE SAME

(71) Applicant: UBRIGHT OPTRONICS CORPORATION, Taoyuan City (TW)

(72) Inventors: CHING-AN YANG, Taoyuan City (TW); Lung-Pin Hsin, Taoyuan City (TW); Hui-Yong Chen, Taoyuan City (TW); Chien-Chih Lai, Taoyuan City (TW); Yu-Mei Juan, Taoyuan City (TW); Chia-Yeh Miu, Taoyuan City (TW); Ge-Wei Lin, Taoyuan City (TW); Ming Te Huang, Taoyuan City (TW); CHENG CHIEH CHIU, Taoyuan City (TW); WEN JEN WU, Taoyuan City (TW)

(21) Appl. No.: 18/198,845

(22) Filed: May 18, 2023

Related U.S. Application Data
(63) Continuation-in-part of application No. 17/975,637, filed on Oct. 28, 2022.
(60) Provisional application No. 63/343,104, filed on May 18, 2022.
(60) Provisional application No. 63/279,187, filed on Nov. 15, 2021.
(60) Provisional application No. 63/273,154, filed on Oct. 29, 2021.

(51) Int. Cl. G02B 1/00; G02B 1/10; G02B 5/02; G02B 27/00

(52) U.S. Cl. CPC G02B 1/002; G02B 1/10; G02B 5/021; G02B 27/0012

(57) ABSTRACT

An optical structure, comprising an optical film having a substrate, wherein a first plurality of multi-faceted recesses are formed on the top surface of the substrate, wherein a prism module is disposed over the first optical film, wherein the prism module comprises a plurality of prism sheets that are stacked and bonded to each other.

### CROSS-REFERENCE TO RELATED APPLICATION

This application is a continuation-in-part of U.S. Pat. Application No. 17/975,637, filed on Oct. 28, 2022, which claims the benefit of U.S. Provisional Pat. Application No. 63/273,154, filed on Oct. 29, 2021 and U.S. Provisional Pat. Application No. 63/279,187, filed on Nov. 15, 2021, each of the above applications is hereby incorporated herein by reference; this application also claims the benefit of U.S. Provisional Pat. Application No. 63/343,104, filed on May 18, 2022, which is hereby incorporated herein by reference.

### BACKGROUND OF THE INVENTION

### 1. Field of the Invention

The present invention relates to an optical film, and more particularly to a composite optical film.

### 2. Description of Related Art

High brightness, higher light-splitting effect, high resolution, and “thin and light” are the directions of displays. However, to achieve the above-mentioned goals, the overall thickness of the backlight module will be too high by using conventional methods.

Furthermore, the conventional methods cannot achieve the true Roll-to-Roll manufacturing process for mass production.

Accordingly, the present invention proposes a new solution to overcome the above-mentioned disadvantages.

### SMMMARY OF THE INVENTION

One objective of the present invention is to form a multi-faceted recess structure on an optical film by a roller having a polyhedron structure protruded thereon, such that the multi-faceted recess structure on the optical film is continuous with no joints structure for roll-to-roll mass production, which also can reduce the total thickness of a backlight module.

In one embodiment, the optical film with the multi-faceted recess structure thereon is used for lights homogenization when the lights enter the bottom side of the optical film and leave the multi-faceted recess structure, thereby increasing the light-splitting effect and reducing the MURA effect and avoiding the formation of shadows after the light penetrates the optical film.

In one embodiment, an optical structure is disclosed, wherein the optical structure comprises: a first composite optical film, comprising a substrate, wherein a first material comprising a first photocurable resin is coated on a first surface of the first substrate, wherein a first plurality of multi-faceted recesses are formed in the first photocurable resin, wherein the first plurality of multi-faceted recesses are distributed side by side along a length and a width of the first substrate to form a first matrix of multi-faceted recesses, wherein the first matrix of multi-faceted recesses comprises a first plurality of rows of multi-faceted recesses and a first plurality of columns of multi-faceted recesses, at least two multi-faceted recesses are in each row of said rows of multi-faceted recesses, and at least two multi-faceted recesses are in each column of said columns of multi-faceted recesses, wherein there is no gap between each two adjacent multi-faceted recesses; and a prism module, disposed over the first optical film, wherein the prism module comprises a plurality of prism sheets that are stacked and bonded to each other, wherein each prism sheet comprises a plurality of prisms on a top side of the prism sheet, wherein for each two adjacent prism sheets, a first plurality of prisms on a top side of a lower prism sheet of said two adjacent prism sheets is bonded to a bottom surface of an upper prism sheet of said two adjacent prism sheets.

In one embodiment, a first diffusion layer is bonded to a bottom surface of a bottom prism sheet of the plurality of prism sheets, wherein a plurality of beads are disposed in the first diffusion layer, wherein the first diffusion layer is disposed over the first optical film.

In one embodiment, a first diffusion layer is bonded to a bottom surface of a bottom prism sheet of the plurality of prism sheets, wherein a bottom surface of the first diffusion layer comprises an embossed surface, wherein the first diffusion layer is disposed over the first optical film.

In one embodiment, a second diffusion layer is bonded to a bottom surface of the first composite optical film, wherein a plurality of beads are disposed in the second diffusion layer.

In one embodiment, a second diffusion layer is bonded to a bottom surface of the first composite optical film, wherein a bottom surface of the second diffusion layer comprises an embossed surface.

In one embodiment, a second diffusion layer is bonded to a bottom surface of the first composite optical film, wherein a plurality of beads are disposed in the second diffusion layer.

In one embodiment, a second diffusion layer is bonded to a bottom surface of the first composite optical film, wherein a bottom surface of the second diffusion layer comprises an embossed surface.

In one embodiment, the first substrate is made of PET.

In one embodiment, the first photocurable resin is UV resin.

In one embodiment, the first photocurable resin of the first material comprises at least one of the following materials: Epoxy, Acrylate, Polyamide, Polyimide, and Polyisoprene.

In one embodiment, the first material comprises PMMA (polymethyl methacrylate) that is coated on the top surface of the substrate, wherein the first plurality of multi-faceted recesses are formed in the PMMA.

In one embodiment, each of the plurality of multi-faceted recesses is a conical recess.

In one embodiment, each of the plurality of multi-faceted recesses has a shape of a reversed pyramid.

In one embodiment, a bottom surface of the substrate is coated with a second material comprises a second photocurable resin, wherein a second plurality of multi-faceted recesses are formed in the second photocurable resin of the second material, wherein the second plurality of multi-faceted recesses are distributed side by side along the length and the width of the first substrate to form a second matrix of multi-faceted recesses, wherein the second matrix of multi-faceted recesses comprises a second plurality of rows of multi-faceted recesses and a second plurality of columns of multi-faceted recesses, wherein at least two multi-faceted recesses are in each of said rows of multi-faceted recesses, and at least two multi-faceted recesses are in each of said columns of multi-faceted recesses, wherein there is no gap between each two adjacent multi-faceted recesses.

In one embodiment, the second photocurable resin of the second material comprises at least one of the following materials: Epoxy, Acrylate, Polyamide, Polyimide, and Polyisoprene.

In one embodiment, the second surface of the substrate comprises a microstructure having an uneven appearance to enhance the optical haze.

In one embodiment, the first diffusion layer comprises a third photocurable resin, wherein the beads are disposed in said third photocurable resin.

In one embodiment, the first diffusion layer comprises a third photocurable resin, wherein the embossed surface are formed in said third photocurable resin.

In one embodiment, the second diffusion layer comprises a fourth photocurable resin, wherein the beads are disposed in said fourth photocurable resin.

In one embodiment, the second diffusion layer comprises a fourth photocurable resin, wherein the embossed surface are formed in said fourth photocurable resin.

In one embodiment, the prism module comprises more than two prism sheets that are stacked and bonded to each other.

The detailed technology and above-preferred embodiments implemented for the present invention are described in the following paragraphs accompanying the appended drawings for people skilled in this field to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1A illustrates a schematic top view of an optical film according to one embodiment of the present invention;

FIG. 1B illustrates a schematic top view of an optical film according to one embodiment of the present invention;

FIG. 2A illustrates a conical structure formed on the substrate in FIG. 1A and FIG. 1B.

FIG. 2B illustrates another conical structure formed on the substrate in FIG. 1A and FIG. 1B.

FIG. 2C illustrates another conical structure formed on the substrate in FIG. 1A and FIG. 1B.

FIG. 2D illustrates a cross-sectional view, wherein the top surface of the substrate has a first plurality of multi-faceted recesses and the bottom surface of the substrate has a second plurality of multi-faceted recesses.

FIG. 3 illustrates a schematic top view of a prism module according to one embodiment of the present invention;

FIG. 4 illustrates a schematic top view of a prism module according to one embodiment of the present invention;

FIG. 5 illustrates a schematic top view of a composite optical film according to one embodiment of the present invention;

FIG. 6A illustrates a schematic top view of a composite optical film according to one embodiment of the present invention;

FIG. 6B illustrates a schematic top view of a composite optical film according to one embodiment of the present invention;

FIG. 6C illustrates a schematic top view of a backlight module according to one embodiment of the present invention;

FIG. 7 illustrates a schematic top view of an optical structure according to one embodiment of the present invention;

FIG. 8 illustrates a schematic top view of an optical structure according to one embodiment of the present invention;

FIG. 9 illustrates a schematic top view of an optical structure according to one embodiment of the present invention;

FIG. 10 illustrates a schematic top view of an optical structure according to one embodiment of the present invention;

FIG. 11A illustrates a schematic top view of an optical structure according to one embodiment of the present invention;

FIG. 11B illustrates a schematic top view of a backlight module according to one embodiment of the present invention;

FIG. 12 illustrates a schematic top view of an optical structure according to one embodiment of the present invention;

FIG. 13 illustrates a schematic top view of an optical structure according to one embodiment of the present invention; and

FIG. 14 illustrates a method to form a composite optical film according to one embodiment of the present invention;

FIG. 15 illustrates a method to form a plurality of composite optical films according to one embodiment of the present invention;

FIG. 16 illustrates a method to form a plurality of composite optical films according to one embodiment of the present invention; and

FIG. 17 illustrates a method to form a plurality of composite optical films according to one embodiment of the present invention.

### DESCRIPTIONS OF THE ILLUSTRATED EMBODIMENTS

The detailed explanation of the present invention is described as follows. The described preferred embodiments are presented for purposes of illustrations and description and they are not intended to limit the scope of the present invention.

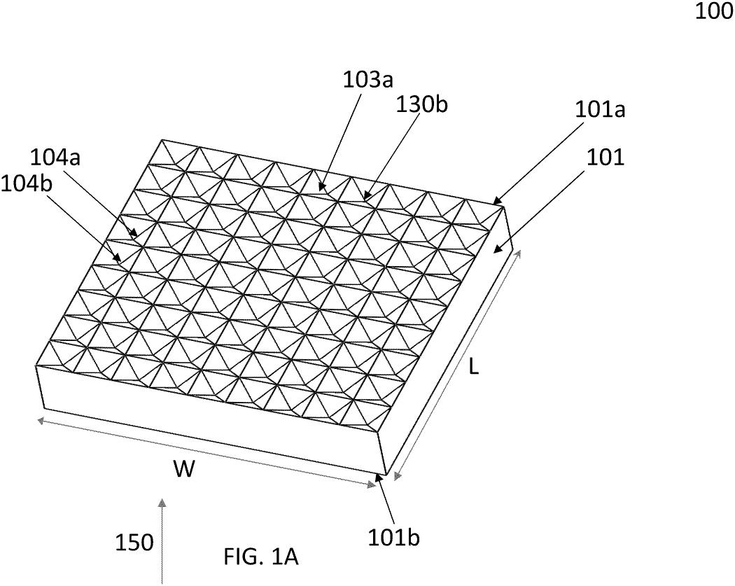

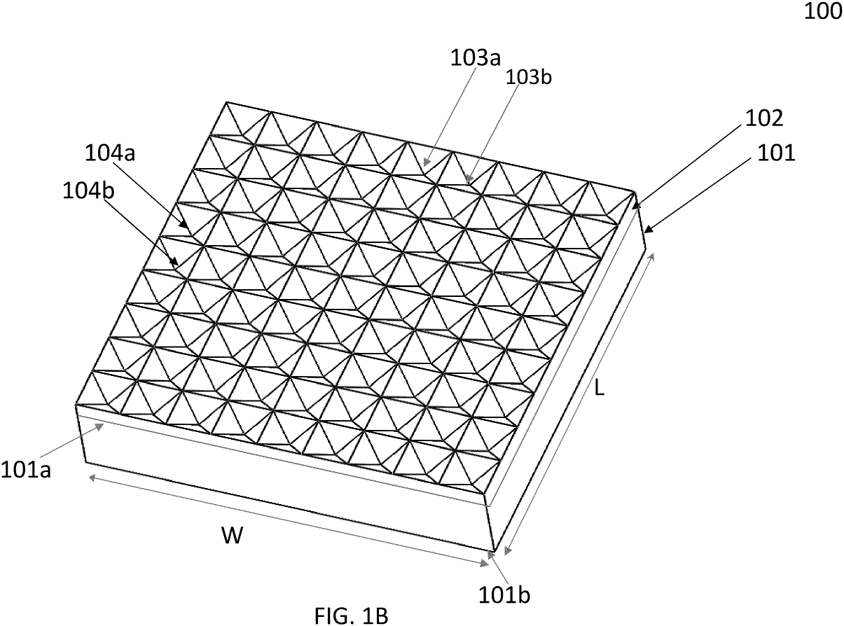

FIG. 1A illustrates a schematic top view of an optical film 100 according to one embodiment of the present invention, wherein the optical film 100 comprises a substrate 101, wherein a plurality of multi-faceted recesses 103a, 103b, 104a, 104b are formed on a first surface 101a of the substrate 101, wherein the plurality of multi-faceted recesses 103a, 103b, 104a, 104b are capable of scattering lights 150 that enter into a second surface 101b of the substrate 101, wherein the first surface 101a and the second surface 101b are two opposite surfaces of the substrate 101.

In one embodiment, the multi-faceted recess comprises at least three side surfaces.

In one embodiment, multiple multi-faceted recesses 104a, 104b of the plurality of multi-faceted recesses are distributed along the length L of the substrate.

In one embodiment, multiple multi-faceted recesses 103a, 103b of the plurality of multi-faceted recesses are distributed along the width W of the substrate 101.

In one embodiment, multiple multi-faceted recesses of the plurality of multi-faceted recesses 104a, 104b are distributed side by side along the length L of the substrate. That is, there is no gap between two adjacent multi-faceted recesses 104a, 104b.

In one embodiment, multiple multi-faceted recesses 103a, 103b of the plurality of multi-faceted recesses are distributed side by side along the width W of the substrate. That is, there is no gap between two adjacent multi-faceted recesses 103a, 103b.

In one embodiment, multiple multi-faceted recesses of the plurality of multi-faceted recesses 104a, 104b are distributed side by side along the length L of the substrate, and multiple multi-faceted recesses 103a, 103b of the plurality of multi-faceted recesses are distributed side by side along the width W of the substrate. That is, there is no gap between two adjacent multi-faceted recesses 104a, 104b, and there is no gap between two adjacent multi-faceted recesses 103a, 103b.

FIG. 1B illustrates a schematic top view of an optical film 100 according to one embodiment of the present invention, wherein the optical film 100 comprises a substrate 101, wherein a first surface 101a of the substrate 101 is coated with a material 102 comprising resin, wherein a plurality of multi-faceted recesses 103a, 103b, 104a, 104b are formed in the photocurable resin 102, wherein the plurality of multi-faceted recesses 103a, 103b, 104a, 104b are capable of scattering lights 150 that enter into a second surface 101b of the substrate 101, wherein the first surface 101a and the second surface 101b are two opposite surfaces of the substrate 101.

In one embodiment, material 102 comprises PMMA (polymethyl methacrylate). In one embodiment, material 102 comprises photocurable resin, such as Epoxy, Acrylate, Polyamide, Polyimide, and Polyisoprene.

In one embodiment, in FIG. 1A and FIG. 1B, the multi-faceted recess comprises a shape of reversed cone.

In one embodiment, in FIG. 1A and FIG. 1B, the multi-faceted recess comprises a shape of reversed cone with at least three side surfaces.

In one embodiment, in FIG. 1A and FIG. 1B, multiple multi-faceted recesses 104a, 104b of the plurality of multi-faceted recesses are distributed along the length L of the substrate.

In one embodiment, in FIG. 1A and FIG. 1B, multiple multi-faceted recesses 103a, 103b of the plurality of multi-faceted recesses are distributed along the width W of the substrate 101.

In one embodiment, in FIG. 1A and FIG. 1B, multiple multi-faceted recesses of the plurality of multi-faceted recesses 104a, 104b are distributed side by side along the length L of the substrate. That is, there is no gap between two adjacent multi-faceted recesses 104a, 104b.

In one embodiment, in FIG. 1A and FIG. 1B, multiple multi-faceted recesses 103a, 103b of the plurality of multi-faceted recesses are distributed side by side along the width W of the substrate. That is, there is no gap between two adjacent multi-faceted recesses 103a, 103b.

In one embodiment, in FIG. 1A and FIG. 1B, multiple multi-faceted recesses of the plurality of multi-faceted recesses 104a, 104b are distributed side by side along the length L of the substrate, and multiple multi-faceted recesses 103a, 103b of the plurality of multi-faceted recesses are distributed side by side along the width W of the substrate. That is, there is no gap between two adjacent multi-faceted recesses 104a, 104b, and there is no gap between two adjacent multi-faceted recesses 103a, 103b.

In one embodiment, in FIG. 1A and FIG. 1B, each of the plurality of multi-faceted recesses 103a, 103b, 104a, 104b is a conical recess.

In one embodiment, in FIG. 1A and FIG. 1B, each of the plurality of multi-faceted recesses 103a, 103b, 104a, 104b is a reversed-pyramid recess.

In one embodiment, in FIG. 1A and FIG. 1B, each of the plurality of multi-faceted recesses comprises four slopped side surfaces, wherein each sloped side surface leans inward.

In one embodiment, in FIG. 1A and FIG. 1B, each of the plurality of multi-faceted recesses comprises at least three slopped side surfaces and a bottom surface, wherein each sloped side surface leans inward to the bottom surface.

In one embodiment, in FIG. 1A and FIG. 1B, each of the plurality of multi-faceted recesses comprises four slopped side surfaces and a bottom surface, wherein each sloped side surface leans inward to the bottom surface.

In one embodiment, in FIG. 1A and FIG. 1B, the second surface of the substrate comprises a microstructure having an uneven appearance to enhance the optical haze.

In one embodiment, in FIG. 1A and FIG. 1B, the microstructure is formed by coating an organic polymer with a plurality of particles embedded therein.

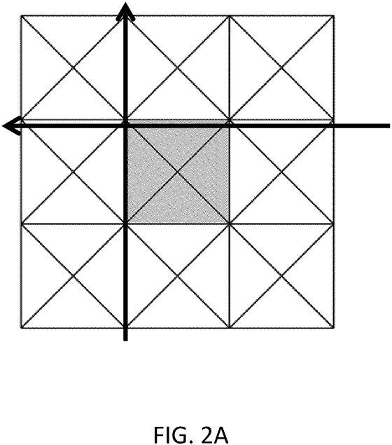

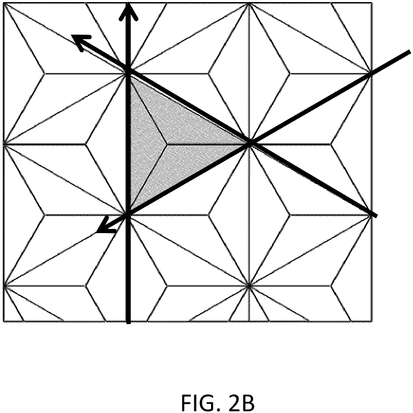

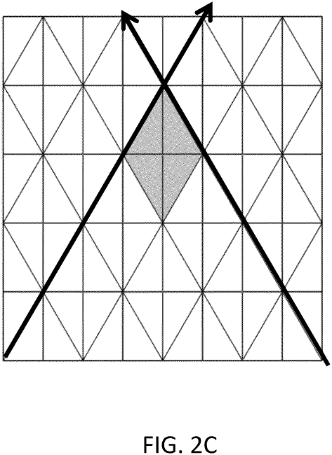

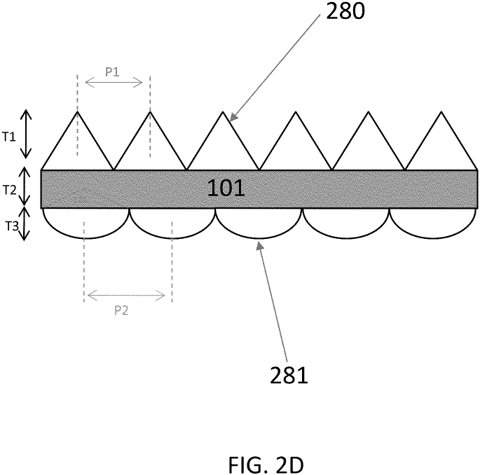

FIG. 2A illustrates a square cone formed on the substrate 101 in FIG. 1A and FIG. 1B by the corresponding structure protruding on the mod 250.

FIG. 2B illustrates a tri-angle cone formed on the substrate 101 in FIG. 1A and FIG. 1B by the corresponding structure protruding on the mod 250.

FIG. 2C illustrates a pyramid formed on the substrate 101 in FIG. 1A and FIG. 1B by the corresponding structure protruding on the mod 250.

Please note that each of the top surface and the bottom surfaces of the substrate 101 can have a structure formed by a mod having a corresponding structure thereon.

FIG. 2D illustrates a cross-sectional view of an optical film, wherein the top surface of a substrate 101 comprises a first structure that comprises a first plurality of multi-faceted recesses 280 formed by a mod having a corresponding structure. The bottom surface of the substrate 101 comprises a second structure that comprises a second plurality of multi-faceted recesses 281 formed by a mod having a corresponding structure. In one embodiment, the pitch P1 of between each two adjacent multi-faceted recesses of the first plurality of multi-faceted recesses 280 is the same as the pitch P2 of between each two adjacent multi-faceted recesses of the second plurality of multi-faceted recesses 281. In one embodiment, the pitch P1 of between each two adjacent multi-faceted recesses of the first plurality of multi-faceted recesses 280 is different from the pitch P2 of between each two adjacent multi-faceted recesses of the second plurality of multi-faceted recesses 281. In one embodiment, the pitch P1 is in a range of 56-60 µm and the pitch P2 is in a range of 59-63 µm. In one embodiment, the thickness T1 of a multi-faceted recess of the first plurality of multi-faceted recesses 280 is in a range of 10-30 µm; the thickness T2 of the substrate, which can be made of PET, is in a range of 30-300 µm; the thickness T3 of a multi-faceted recess of the second plurality of multi-faceted recesses 281 is in a range of 5-50 µm. the total thickness of T1, T2, and T3 is in a range of 40-400 µm. The optical film of FIG. 2D can reduce the MURA effect by the circular shape structure at the bottom surface of substrate 101 and avoid the formation of shadows after the light penetrates the optical film by the first plurality of multi-faceted recesses 280 formed on the top surface of the substrate 101.

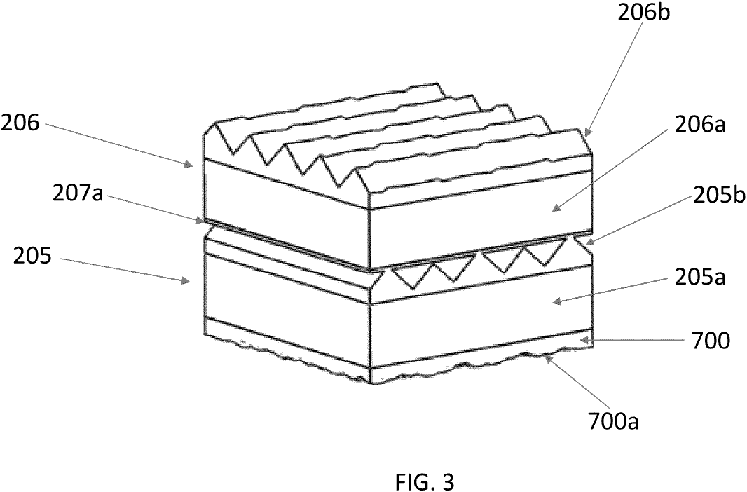

FIG. 3 illustrates a schematic top view of a prism module 300 according to one embodiment of the present invention, wherein the prism module 300 comprises a plurality of prism sheets 205, 206 that are stacked and bonded to each other, wherein each prism sheet 205, 206 comprises a plurality of prisms 205b, 20b on a top side of the prism sheet 205, 206, wherein for each two adjacent prism sheets 205, 206, a first plurality of prisms 205b on a top side of a lower prism sheet 205 of said two adjacent prism sheets 205, 206 is bonded to a bottom surface of an upper prism sheet 206 of said two adjacent prism sheets 205, 206.

In one embodiment, as shown in FIG. 3, the prism module 300 further comprises an adhesive layer 207a, wherein the prism sheet 205 is attached to the prism sheet 206 by the adhesive layer 207a disposed between the prism sheet 205 and the prism sheet 206.

In one embodiment, a top part of the first plurality of prisms 205a is embedded in the adhesive layer 207a.

In one embodiment, as shown in FIG. 3, a diffusion layer 700 is bonded to a bottom surface of a bottom prism sheet 700.

In one embodiment, as shown in FIG. 3, a bottom surface of the diffusion layer 700 comprises an embossed surface 700a.

In one embodiment, in the prism module comprises more than two prism sheets that are stacked and bonded to each other.

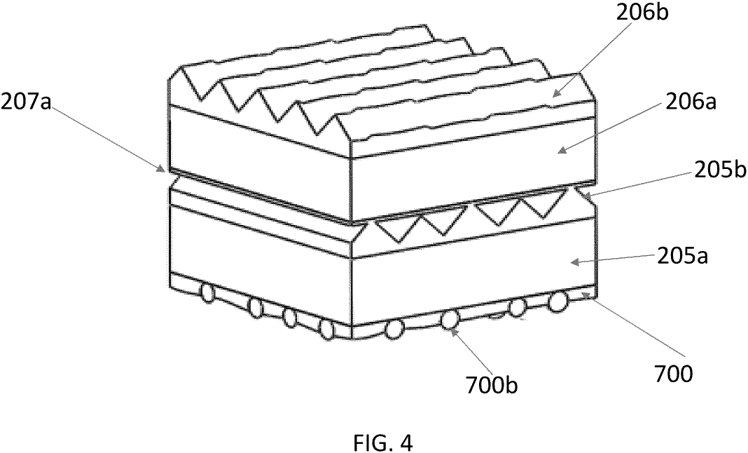

In one embodiment, as shown in FIG. 4, a plurality of beads 700b are disposed in the diffusion layer 700.

In one embodiment, a first UV resin is coated on the bottom surface of prism sheet 206 and the tips of the prisms of prism sheet 205 are immersed in said first UV resin, and a second UV resin is coated on the bottom surface of the prism sheet 205, wherein the second UV resin is embossed to form a diffusing layer. Finally, the whole body is formed into a double-sheet module after being irradiated with UV light.

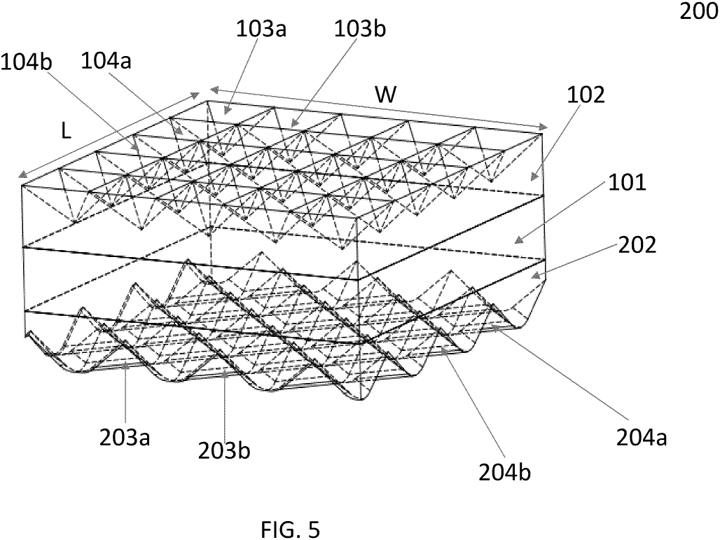

FIG. 5 illustrates a schematic top view of a composite optical film 200 according to one embodiment of the present invention, wherein the composite optical film 200 comprises a first substrate 101, wherein a first material comprising a first photocurable resin 102 is coated on a first surface of the first substrate 101, wherein a first plurality of multi-faceted recesses 103a, 103b, 104a, 104b are formed in the first photocurable resin 102, wherein the first plurality of multi-faceted recesses 103a, 103b, 104a, 104b are distributed side by side along a length L and a width W of the first substrate 101 to form a first matrix of multi-faceted recesses, wherein the first matrix of multi-faceted recesses comprises a first plurality of rows of multi-faceted recesses and a first plurality of columns of multi-faceted recesses, wherein at least two multi-faceted recesses are in each row of the first plurality of rows of multi-faceted recesses, and at least two multi-faceted recesses are in each column of the first plurality of columns of multi-faceted recesses, wherein there is no gap between each two adjacent multi-faceted recesses of the first plurality of multi-faceted recesses 103a, 103b, 104a, 104b, wherein a second material comprising a second photocurable resin 202 is coated on a bottom surface of the first substrate 101, wherein a second plurality of multi-faceted recesses 203a, 203b, 204a, 204b are formed in the second photocurable resin 202, wherein the second plurality of multi-faceted recesses 203a, 203b, 204a, 204b are distributed side by side along a length L and a width W of the first substrate 101 to form a second matrix of multi-faceted recesses, wherein the second matrix of multi-faceted recesses comprises a second plurality of rows of multi-faceted recesses and a second plurality of columns of multi-faceted recesses, wherein at least two multi-faceted recesses are in each row of the second plurality of rows of multi-faceted recesses, and at least two multi-faceted recesses are in each column of the second plurality of columns of multi-faceted recesses, wherein there is no gap between each two adjacent multi-faceted recesses of the second plurality of multi-faceted recesses 203a, 203b, 204a, 204b.

In one embodiment, the first plurality of multi-faceted recesses 103a, 103b, 104a, 104b and the second plurality of multi-faceted recesses 203a, 203b, 204a, 204b are mirror images of each other.

In one embodiment, the first substrate 101 comprises PET.

In one embodiment, the first photocurable resin 102 comprises UV resin.

In one embodiment, the second photocurable resin 202 comprises at least one of the following materials: Epoxy, Acrylate, Polyamide, Polyimide, and Polyisoprene.

In one embodiment, the first material comprises PMMA (polymethyl methacrylate) that is coated on the top surface of the substrate, wherein the first plurality of multi-faceted recesses are formed in the PMMA.

In one embodiment, the second material comprises PMMA (polymethyl methacrylate) that is coated on the top surface of the substrate, wherein the second plurality of multi-faceted recesses are formed in the PMMA.

In one embodiment, each of the plurality of multi-faceted recesses is a conical recess.

In one embodiment, each of the plurality of multi-faceted recesses has a shape of a reversed pyramid.

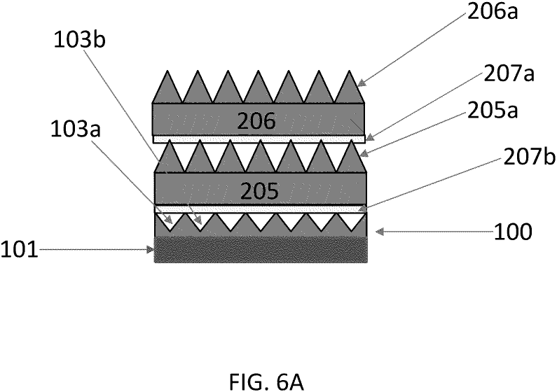

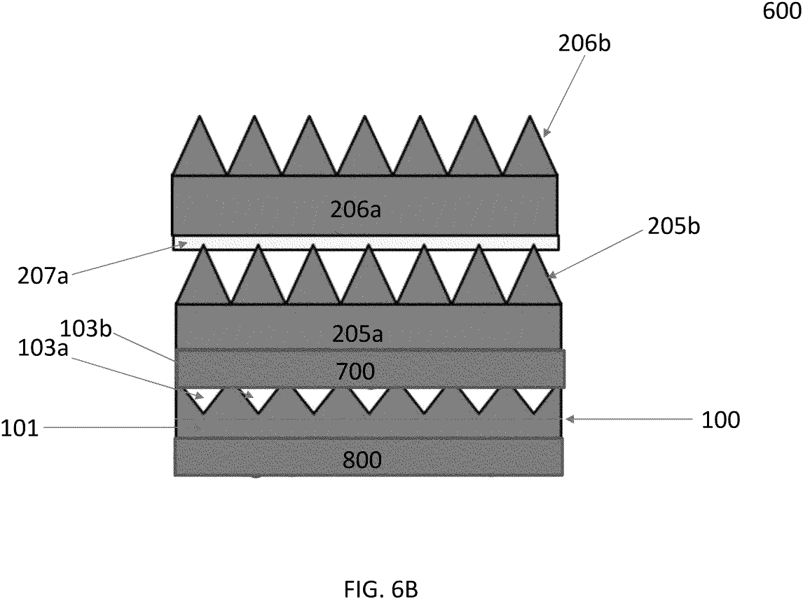

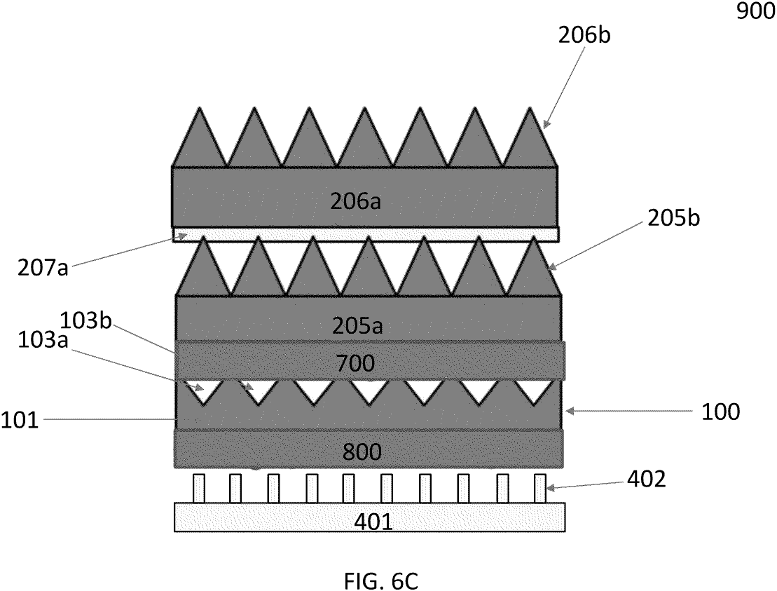

FIG. 6A illustrates a schematic top view of an optical structure 600 according to one embodiment of the present invention, wherein the optical structure 600 comprises: a first composite optical film 100, as shown in FIG. 1B, wherein the first composite optical film 100 comprising a first substrate 101, wherein a first material comprising a first photocurable resin 102 is coated on a first surface of the first substrate 101, wherein a first plurality of multi-faceted recesses 103a, 103b are formed in the first photocurable resin 102, as shown in FIG. 1B, wherein the first plurality of multi-faceted recesses 103a, 103b are distributed side by side along a length L and a width W of the first substrate 101 to form a first matrix of multi-faceted recesses, as shown in FIG. 1B, wherein the first matrix of multi-faceted recesses comprises a first plurality of rows of multi-faceted recesses and a first plurality of columns of multi-faceted recesses, wherein at least two multi-faceted recesses are in each row of the first plurality of rows of multi-faceted recesses, and at least two multi-faceted recesses are in each column of the first plurality of columns of multi-faceted recesses, wherein there is no gap between each two adjacent multi-faceted recesses of the first plurality of multi-faceted recesses 103a, 103b; and a prism module, disposed over the first optical film, wherein the prism module comprises a plurality of prism sheets 205, 206 that are stacked and bonded to each other, wherein each prism sheet 205, 206 comprises a plurality of prisms 205b, 20b on a top side of the prism sheet 205, 206, wherein for each two adjacent prism sheets 205, 206, a first plurality of prisms 205b on a top side of a lower prism sheet 205 of said two adjacent prism sheets 205, 206 is bonded to a bottom surface of an upper prism sheet 206 of said two adjacent prism sheets 205, 206.

In one embodiment, as shown in FIG. 6A, wherein the prism sheet 205 is attached to the prism sheet 206 by an adhesive layer 207a disposed between the prism sheet 205 and the prism sheet 206.

In one embodiment, as shown in FIG. 6A, wherein the first composite optical film 100 is attached to the prism sheet 205 by an adhesive layer 208a disposed between the prism sheet 205 and the first composite optical film 100.

In one embodiment, a top part of the first plurality of prisms 205a is embedded in the adhesive layer 207a.

In one embodiment, as shown in FIG. 6B, a first diffusion layer 700 is bonded to a bottom surface of a bottom prism sheet 205 of the plurality of prism sheets 205, 206, and a second diffusion layer 800 is bonded to a bottom surface of the first substrate 101.

FIG. 6C illustrates a schematic top view of a backlight module 900 according to one embodiment of the present invention, wherein the backlight module 900 comprises the composite an optical structure 600 as shown in FIG. 6B and a light source 401 located under the optical structure 600. In one embodiment, the light source 401 comprises a plurality of mini-LED(s) 402, wherein the plurality of mini-LED(s) 402 emits lights into the first substrate 101 via the bottom surface of the first substrate 101.

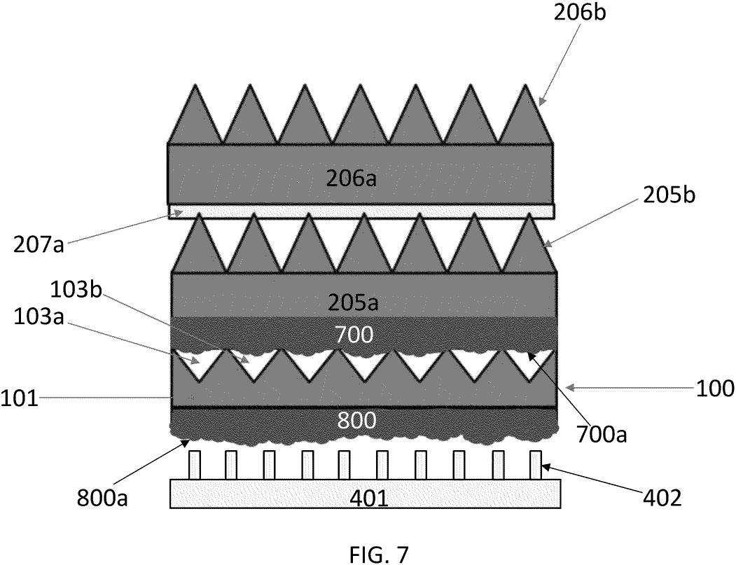

In one embodiment, as shown in FIG. 7, a first diffusion layer 700 is bonded to a bottom surface of a bottom prism sheet 205 of the plurality of prism sheets 205, 206, wherein a bottom surface of the first diffusion layer 700 comprises a first embossed surface 700a, wherein the first diffusion layer 700 is disposed over the first optical film 100, wherein a second diffusion layer 800 is bonded to a bottom surface of the first composite optical film 100, wherein a bottom surface of the second diffusion layer 800 comprises a second embossed surface 800a.

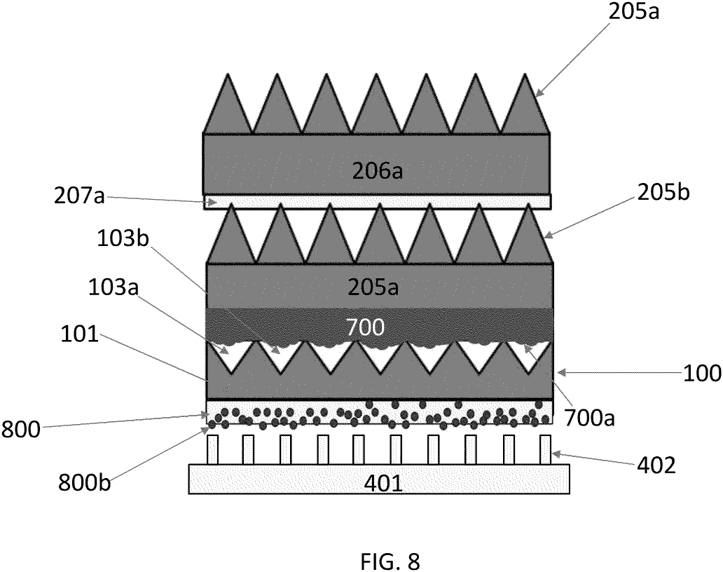

In one embodiment, as shown in FIG. 8, a first diffusion layer 700 is bonded to a bottom surface of a bottom prism sheet 205 of the plurality of prism sheets 205, 206, wherein a bottom surface of the first diffusion layer 700 comprises a first embossed surface 700a, wherein the first diffusion layer 700 is disposed over the first optical film 100, wherein a second diffusion layer 800 is bonded to a bottom surface of the first composite optical film 100, wherein a plurality of beads 800b are disposed in the second diffusion layer 800.

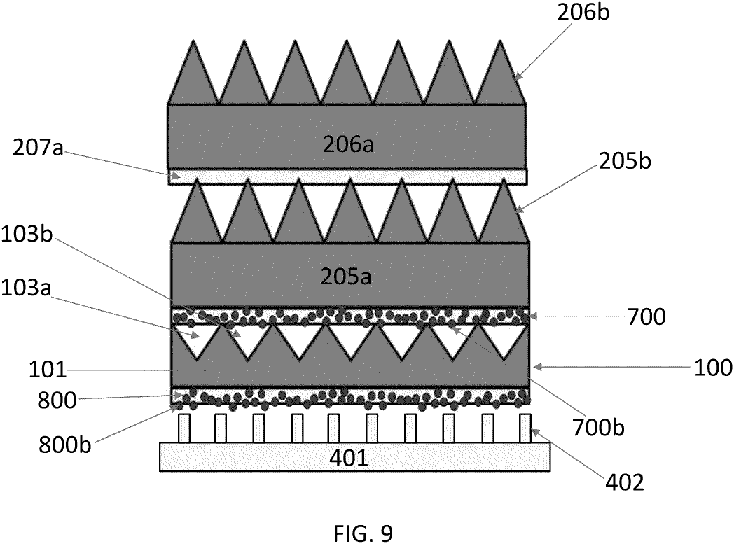

In one embodiment, as shown in FIG. 9, a first diffusion layer 700 is bonded to a bottom surface of a bottom prism sheet 205 of the plurality of prism sheets 205, 206, wherein a plurality of beads 700b are disposed in the first diffusion layer 700, wherein the first diffusion layer 700 is disposed over the first optical film 100, wherein a second diffusion layer 800 is bonded to a bottom surface of the first composite optical film 100, wherein a plurality of beads 800b are disposed in the second diffusion layer 800.

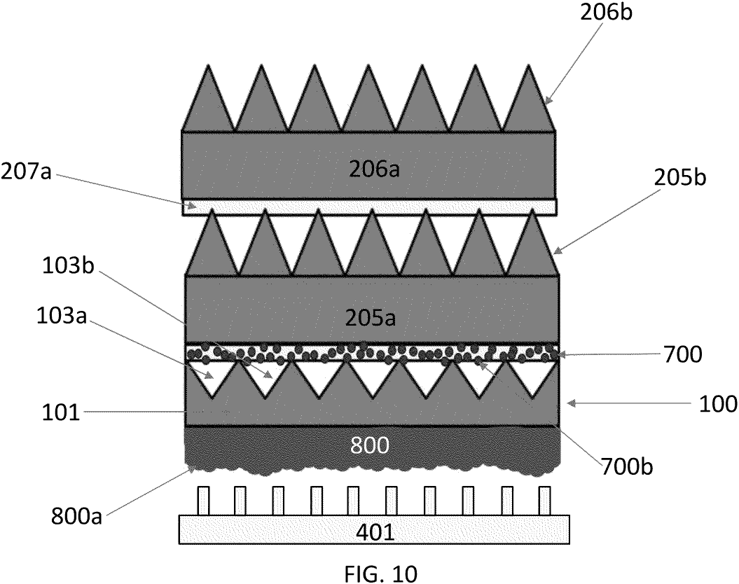

In one embodiment, as shown in FIG. 10, a first diffusion layer 700 is bonded to a bottom surface of a bottom prism sheet 205 of the plurality of prism sheets 205, 206, wherein a plurality of beads 700b are disposed in the first diffusion layer 700, wherein the first diffusion layer 700 is disposed over the first optical film 100, wherein a second diffusion layer 800 is bonded to a bottom surface of the first composite optical film 100, wherein a bottom surface of the second diffusion layer 800 comprises a second embossed surface 800a.

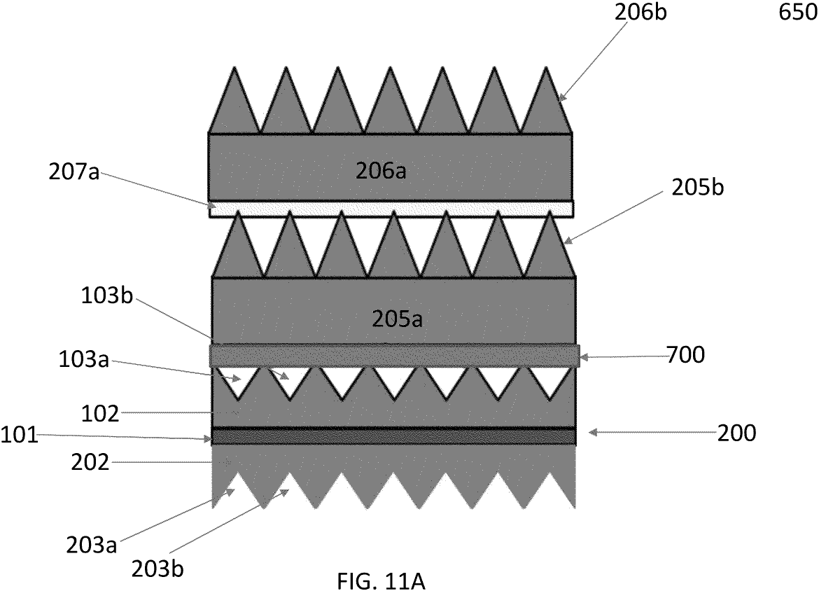

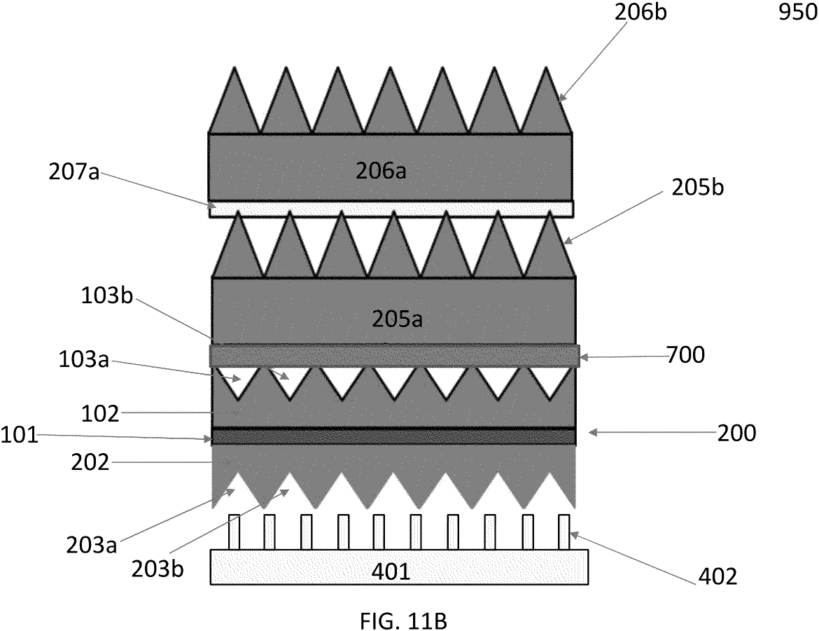

FIG. 11A illustrates a schematic top view of an optical structure 650 according to one embodiment of the present invention, wherein the optical structure 650 comprises: a first composite optical film 200, as shown in FIG. 5, wherein the composite optical film 200 comprises a first substrate 101, wherein a first material comprising a first photocurable resin 102 is coated on a first surface of the first substrate 101, wherein a first plurality of multi-faceted recesses 103a, 103b, 104a, 104b are formed in the first photocurable resin 102, wherein the first plurality of multi-faceted recesses 103a, 103b, 104a, 104b are distributed side by side along a length L and a width W of the first substrate 101 to form a first matrix of multi-faceted recesses, wherein the first matrix of multi-faceted recesses comprises a first plurality of rows of multi-faceted recesses and a first plurality of columns of multi-faceted recesses, wherein at least two multi-faceted recesses are in each row of the first plurality of rows of multi-faceted recesses, and at least two multi-faceted recesses are in each column of the first plurality of columns of multi-faceted recesses, wherein there is no gap between each two adjacent multi-faceted recesses of the first plurality of multi-faceted recesses 103a, 103b, 104a, 104b, wherein a second material comprising a second photocurable resin 202 is coated on a bottom surface of the first substrate 101, wherein a second plurality of multi-faceted recesses 203a, 203b, 204a, 204b are formed in the second photocurable resin 202, wherein the second plurality of multi-faceted recesses 203a, 203b, 204a, 204b are distributed side by side along a length L and a width W of the first substrate 101 to form a second matrix of multi-faceted recesses, wherein the second matrix of multi-faceted recesses comprises a second plurality of rows of multi-faceted recesses and a second plurality of columns of multi-faceted recesses, wherein at least two multi-faceted recesses are in each row of the second plurality of rows of multi-faceted recesses, and at least two multi-faceted recesses are in each column of the second plurality of columns of multi-faceted recesses, wherein there is no gap between each two adjacent multi-faceted recesses of the second plurality of multi-faceted recesses 203a, 203b, 204a, 204b ; and a prism module, disposed over the first optical film, wherein the prism module comprises a plurality of prism sheets 205, 206 that are stacked and bonded to each other, wherein each prism sheet 205, 206 comprises a plurality of prisms 205b, 20b on a top side of the prism sheet 205, 206, wherein for each two adjacent prism sheets 205, 206, a first plurality of prisms 205b on a top side of a lower prism sheet 205 of said two adjacent prism sheets 205, 206 is bonded to a bottom surface of an upper prism sheet 206 of said two adjacent prism sheets 205, 206.

In one embodiment, as shown in FIG. 11A, a first diffusion layer 700 is bonded to a bottom surface of a bottom prism sheet 205 of the plurality of prism sheets 205, 206.

FIG. 11B illustrates a schematic top view of a backlight module 950 according to one embodiment of the present invention, wherein the backlight module 950 comprises the optical structure 650 as shown in FIG. 11A and a light source 401 located under the first composite optical film 200. In one embodiment, the light source 401 comprises a plurality of mini-LED(s) 402.

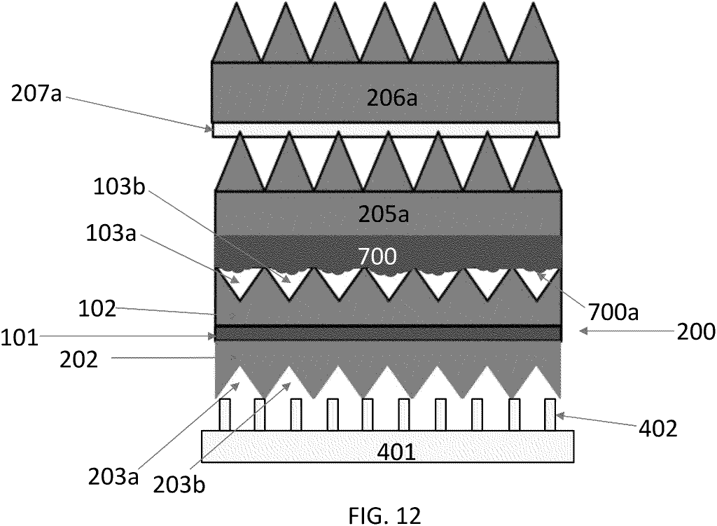

In one embodiment, as shown in FIG. 12, a first diffusion layer 700 is bonded to a bottom surface of a bottom prism sheet 205 of the plurality of prism sheets 205, 206, wherein a bottom surface of the first diffusion layer 700 comprises a first embossed surface 700a, wherein the first diffusion layer 700 is disposed over the composite optical film 200.

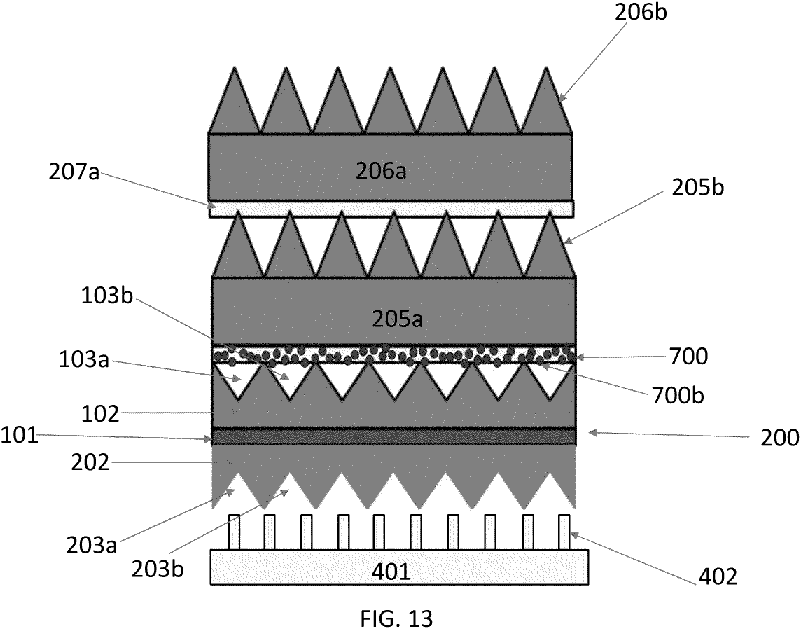

In one embodiment, as shown in FIG. 13, a first diffusion layer 700 is bonded to a bottom surface of a bottom prism sheet 205 of the plurality of prism sheets 205, 206, wherein a plurality of beads 700b are disposed in the first diffusion layer 700, wherein the first diffusion layer 700 is disposed over the composite optical film 200.

In one embodiment, the first diffusion layer 700 comprises a photocurable resin, wherein the beads are disposed in the photocurable resin.

In one embodiment, the first diffusion layer 700 comprises a photocurable resin, wherein the embossed surface are formed in the photocurable resin.

In one embodiment, the second diffusion layer 800 comprises a photocurable resin, wherein the beads are disposed in the photocurable resin.

In one embodiment, the second diffusion layer 800 comprises a photocurable resin, wherein the embossed surface are formed in the photocurable resin.

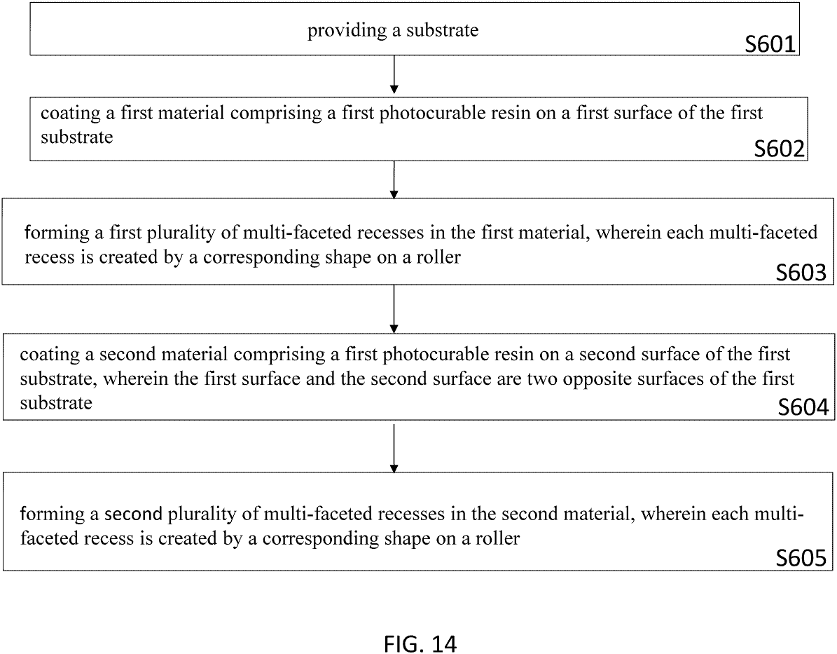

FIG. 14 shows a method for forming a composite optical film according to an embodiment of the present invention, wherein the method includes: step 601S: providing a substrate; step 602S: coating a first material comprising a photocurable resin on a first surface of the substrate; step 603S: forming a first plurality of multi-faceted recesses in the first material, wherein each multi-faceted recess is formed by a corresponding shape protruding on a roller; step 604S: coating a second material comprising a photocurable resin on a second surface of the substrate, wherein the first surface and the second surface are two opposite surfaces of the substrate; step 605S: forming a second plurality of multi-faceted recesses in the second material, wherein each multi-faceted recess is formed by a corresponding shape protruding on a roller.

In one embodiment, the prism module, as shown in FIG. 3 or FIG. 4, can be disposed over the composite optical film.

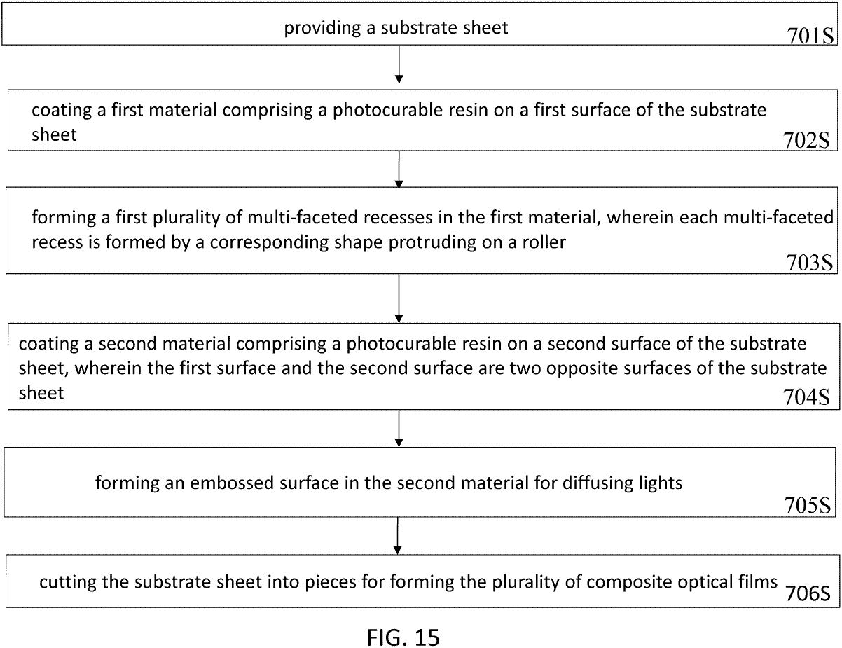

FIG. 15 shows a method for forming a plurality of composite optical films according to an embodiment of the present invention, wherein the method includes: step 701S: providing a substrate sheet; step 702S: coating a first material comprising a photocurable resin on a first surface of the substrate sheet; step 703S: forming a first plurality of multi-faceted recesses in the first material, wherein each multi-faceted recess is formed by a corresponding shape protruding on a roller; step 704S: coating a second material comprising a photocurable resin on a second surface of the substrate sheet, wherein the first surface and the second surface are two opposite surfaces of the substrate sheet; step 705S: forming an embossed surface in the second material or a plurality of beads are in the second material, for diffusing lights; and step 706S: cutting the substrate sheet into pieces for forming the plurality of composite optical films.

In one embodiment, the prism module, as shown in FIG. 3 or FIG. 4, can be disposed over the composite optical film.

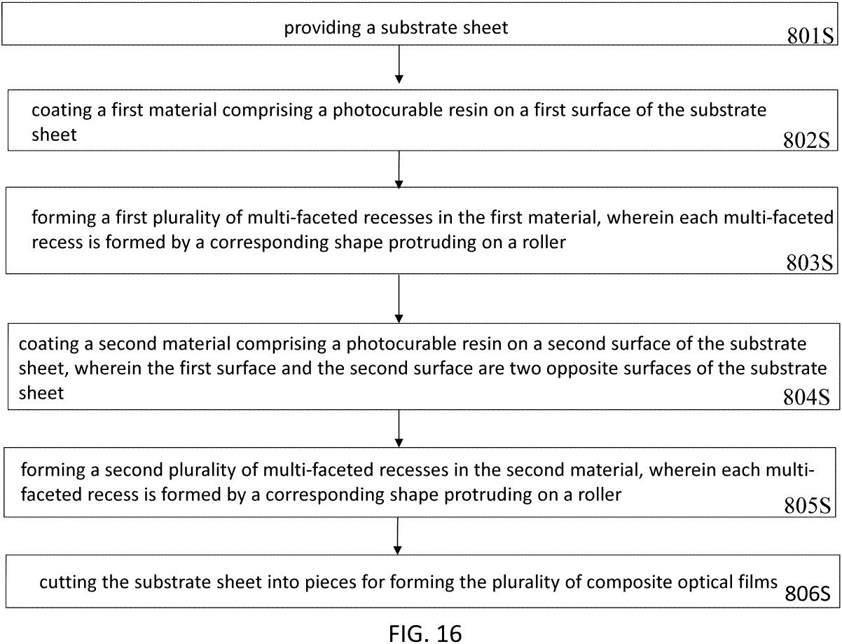

FIG. 16 shows a method for forming a plurality of composite optical films according to an embodiment of the present invention, wherein the method includes: step 801S: providing a substrate sheet; step 802S: coating a first material comprising a photocurable resin on a first surface of the substrate sheet; step 803S: forming a first plurality of multi-faceted recesses in the first material, wherein each multi-faceted recess is formed by a corresponding shape protruding on a roller; step 804S: coating a second material comprising a photocurable resin on a second surface of the substrate sheet, wherein the first surface and the second surface are two opposite surfaces of the substrate sheet; step 805S: forming a second plurality of multi-faceted recesses in the second material, wherein each multi-faceted recess is formed by a corresponding shape protruding on a roller; and step 806S: cutting the substrate sheet into pieces for forming the plurality of composite optical films.

In one embodiment, the prism module, as shown in FIG. 3 or FIG. 4, can be disposed over the composite optical film.

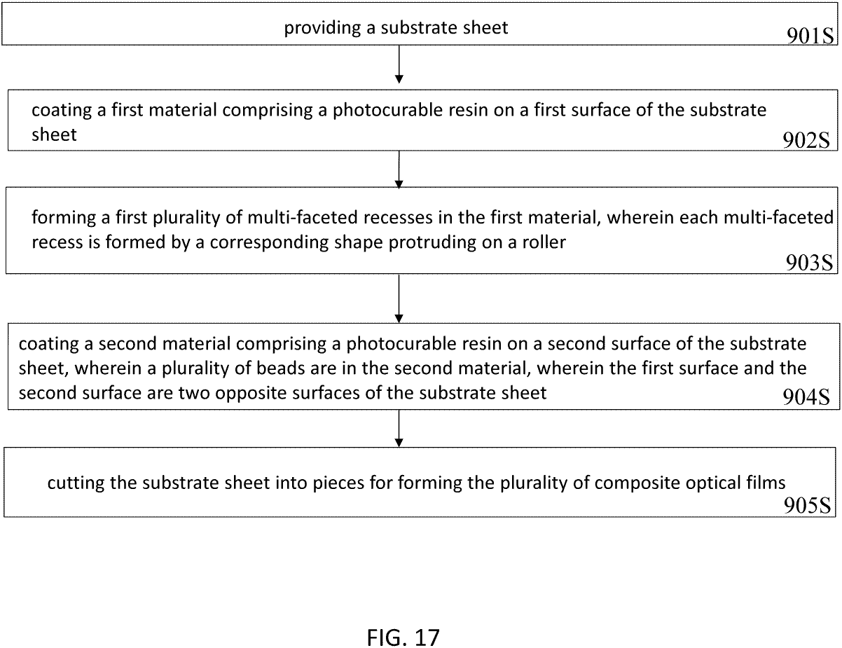

FIG. 17 shows a method for forming a plurality of composite optical films according to an embodiment of the present invention, wherein the method includes: step 901S: providing a substrate sheet; step 902S: coating a first material comprising a photocurable resin on a first surface of the substrate sheet; step 903S: forming a first plurality of multi-faceted recesses in the first material, wherein each multi-faceted recess is formed by a corresponding shape protruding on a roller; step 904S: coating a second material comprising a photocurable resin on a second surface of the substrate sheet, wherein a plurality of beads are in the second material, wherein the first surface and the second surface are two opposite surfaces of the substrate sheet; and step 905S: cutting the substrate sheet into pieces for forming the plurality of composite optical films.

In one embodiment, the prism module, as shown in FIG. 3 or FIG. 4, can be disposed over the composite optical film.

The present invention can reduce the total thickness of the backlight module structure, and at the same time shield the light and shadow of the mini-LED(s) and increase the overall brightness, thereby achieving the purpose of uniforming lights from mini-LED(s) and improving the brightness of the LCD screen.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An optical structure, comprising:
a first composite optical film, comprising a substrate, wherein a first material comprising a first photocurable resin is coated on a first surface of the first substrate, wherein a first plurality of multi-faceted recesses are formed in the first photocurable resin, wherein the first plurality of multi-faceted recesses are distributed side by side along a length and a width of the first substrate to form a first matrix of multi-faceted recesses, wherein the first matrix of multi-faceted recesses comprises a first plurality of rows of multi-faceted recesses and a first plurality of columns of multi-faceted recesses, at least two multi-faceted recesses are in each row of said rows of multi-faceted recesses, and at least two multi-faceted recesses are in each column of said columns of multi-faceted recesses, wherein there is no gap between each two adjacent multi-faceted recesses; and
a prism module, disposed over the first optical film, wherein the prism module comprises a plurality of prism sheets that are stacked and bonded to each other, wherein each prism sheet comprises a plurality of prisms on a top side of the prism sheet, wherein for each two adjacent prism sheets, a first plurality of prisms on a top side of a lower prism sheet of said two adjacent prism sheets is bonded to a bottom surface of an upper prism sheet of said two adjacent prism sheets.

2. The composite optical film according to claim 1, wherein a first diffusion layer is bonded to a bottom surface of a bottom prism sheet of the plurality of prism sheets, wherein a plurality of beads are disposed in the first diffusion layer, wherein the first diffusion layer is disposed over the first optical film.

3. The composite optical film according to claim 1, wherein a first diffusion layer is bonded to a bottom surface of a bottom prism sheet of the plurality of prism sheets, wherein a bottom surface of the first diffusion layer comprises an embossed surface, wherein the first diffusion layer is disposed over the first optical film.

4. The composite optical film according to claim 2, wherein a second diffusion layer is bonded to a bottom surface of the first composite optical film, wherein a plurality of beads are disposed in the second diffusion layer.

5. The composite optical film according to claim 2, wherein a second diffusion layer is bonded to a bottom surface of the first composite optical film, wherein a bottom surface of the second diffusion layer comprises an embossed surface.

6. The composite optical film according to claim 3, wherein a second diffusion layer is bonded to a bottom surface of the first composite optical film, wherein a plurality of beads are disposed in the second diffusion layer.

7. The composite optical film according to claim 3, wherein a second diffusion layer is bonded to a bottom surface of the first composite optical film, wherein a bottom surface of the second diffusion layer comprises an embossed surface.

8. The composite optical film according to claim 3, wherein the first substrate is made of PET.

9. The composite optical film according to claim 3, wherein the first photocurable resin is UV resin that is coated on the top surface of the substrate, wherein the first plurality of multi-faceted recesses are formed in the UV resin.

10. The optical film according to claim 2, wherein the first photocurable resin of the first material comprises at least one of the following materials: Epoxy, Acrylate, Polyamide, Polyimide, and Polyisoprene.

11. The optical film according to claim 1, wherein the first material comprises PMMA (polymethyl methacrylate) that is coated on the top surface of the substrate, wherein the first plurality of multi-faceted recesses are formed in the PMMA.

12. The optical film according to claim 1, wherein each of the plurality of multi-faceted recesses is a conical recess.

13. The optical film according to claim 1, wherein each of the plurality of multi-faceted recesses has a shape of a reversed pyramid.

14. The optical film according to claim 2, wherein a bottom surface of the substrate is coated with a second material comprising a second photocurable resin, wherein a second plurality of multi-faceted recesses are formed in the second photocurable resin.

15. The optical film according to claim 14, wherein the second photocurable resin of the second material comprises at least one of the following materials: Epoxy, Acrylate, Polyamide, Polyimide, and Polyisoprene.

16. The optical film according to claim 2, wherein the first diffusion layer comprises a third photocurable resin, wherein the beads are disposed in said third photocurable resin.

17. The optical film according to claim 3, wherein the first diffusion layer comprises a third photocurable resin, wherein the embossed surface are formed in said third photocurable resin.

18. The optical film according to claim 4, wherein the second diffusion layer comprises a fourth photocurable resin, wherein the beads are disposed in said fourth photocurable resin.

19. The optical film according to claim 5, wherein the second diffusion layer comprises a fourth photocurable resin, wherein the embossed surface are formed in said fourth photocurable resin.

20. The optical film according to claim 1, wherein the prism module comprises more than two prism sheets that are stacked and bonded to each other.
